(19) United States
(12) Patent Application Publication
(10) Pub. No.: US 2012/0126601 A1
(43) Pub. Date: May 24, 2012

(54) SYSTEM, METHOD AND APPARATUS FOR ASSISTING WITH STANDING FROM A SEAT

(76) Inventor: Vincent J. Smith, Largo, FL (US)

(21) Appl. No.: 12/949,555

(22) Filed: Nov. 18, 2010

(51) Int. Cl. A61G 15/06

(52) U.S. Cl. 297/339; 297/452.1

(57) ABSTRACT

An application for an assist chair includes a mechanism for interfacing the assist chair to a floor such as a base and stand and a mechanism for supporting a user of the assist chair such as a seat, seat back and optionally a seat-height adjustment and adjustable seat arms. The assist chair includes one or more devices that capture energy from a user sitting on the mechanism for supporting the user. The device(s) for capturing the energy release the energy when the user transitions from a sitting position on the assist chair to a standing position, thereby assisting the user in attaining the standing position.

### FIELD

This invention relates to the field of rehabilitation and care giving and more particularly to a system for exercising and helping a person stand after being seated.

### BACKGROUND

There exists a large population of people who have physical limitations; either temporary due to an operation or permanent due to a birth defect or a medical condition. At times, some or all of these limitations make it difficult or impossible for a person to transition from a sitting position to a standing position without assistance. For example, a person who has broken their hip or has severe back problems cannot lift to transition themselves from a sitting position into a standing position as can a healthy person. People with various disabling problems often need another person to help them get out of a seat.

To help people with such disabilities, various devices have been introduced into the marketplace to lift the person from the sitting position to allow them to stand. Companies like Med-lift manufacture several electric lift chairs or recliners that provide sufficient lift to elevate the disabled person out of a seat of the device. The chairs and beds sold by these companies use motors and mechanisms to gradually lift the person to a point at which they can disengage with the chair or bed. In many situations, such a system is not desirable, especially for people with temporary disabilities such as after back surgery, hip replacement, etc. In such cases, since the motors of the power lift chairs are doing all of the work for the individual, the muscles normally used by the person to elevate themselves from the sitting position soon weaken or atrophy from lack of use and, eventually, even after the person heals from their operation, they can no longer transition from the sitting position to the standing position without the use of such a power-lift chair (or assistance from another person).

Likewise, other companies make power assist seats such as the UpEasy power seat. These devices fit on an existing chair/seat and convert the chair/seat into a power electric-lift chair. These power seats include an electric lifting cushion that will gently lower, and then later raise the person from an existing armchair or sofa. With just the push of a button, these devices lift a person into a position where they can stand up. As with the chairs above, such a device is not desirable for many people, especially for people with temporary disabilities such as after back surgery, hip replacement, etc. As described previously, the power lift seats are doing all of the work for the individual and the muscles normally used by the person to transition themselves from the sitting position soon weaken or atrophy from lack of use and, eventually, even after the person heals from the operation, they can no longer transition from the sitting position to the standing position without the use of such a power-lift seat, power-lift chair or assistance from another person.

What is needed is a system that will assist a person in standing while providing an adjustable controlled assistance to build and/or maintain muscle mass.

### SUMMARY

In one embodiment, as assist chair system is disclosed including a base with a riser affixed to the base and a seat. The seat is interfaced to a seat lift member that is optionally adjustable in height. An upper pivot arm is interfaced to the seat lift member and pivotally interfaced to the riser while a lower pivot arm is interfaced to the seat lift member and pivotally interfaced to the riser. A spring member adjustment mechanism is interfaced between the riser and the seat lift member. At least one spring member is pivotally connected at a first end to the riser and at a second end to the spring member adjustment member, whereas the at least one spring member compresses and stores energy when a user sits on the seat and the spring member expands and releases the energy when the user transitions from a sitting position to a standing position, assisting the user by pushing upward and forward.

In another embodiment, a method of rehabilitation is disclosed including providing an assist chair. The assist chair has a base with a riser affixed to the base and a seat. The seat is interfaced to a seat lift member that is optionally adjustable in height. An upper pivot arm is interfaced to the seat lift member and pivotally interfaced to the riser while a lower pivot arm is interfaced to the seat lift member and pivotally interfaced to the riser. A spring member adjustment mechanism is interfaced between the riser and the seat lift member. At least one spring member is pivotally connected at a first end to the riser and at a second end to the spring member adjustment member. Responsive to a user sitting on the assist chair, the at least one spring member compressing and storing energy and responsive to a user exerting effort to transition from a sitting position to a standing position, the spring member expanding and releasing the energy, thereby assisting the user by pushing upward and forward on the user.

In another embodiment, an assist chair is disclosed including a mechanism for interfacing the assist chair to a floor such as a base and stand and a mechanism for supporting a user of the assist chair such as a seat, seat back and optionally a seat-height adjustment and adjustable seat arms. The assist chair includes one or more devices that capture energy from a user sitting on the mechanism for supporting the user. The device(s) for capturing the energy release the energy when the user transitions from a sitting position on the assist chair to a standing position, thereby assisting the user in attaining the standing position.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a side perspective view of an assist chair system of a first embodiment.

FIG. 2 illustrates a front perspective view of an assist chair system of the first embodiment.

FIG. 3 illustrates a rear perspective view of an assist chair system of the first embodiment.

FIG. 4 illustrates a rear perspective view of an assist chair system of an alternate embodiment.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. The assist chair disclosed in this specification is the best known embodiment of the device known to the inventor at the time of filing and the described assist chair systems disclosed are examples of the preferred embodiments of the assist chair and many other embodiments are anticipated that achieve similar results. For example, instead of using gas springs, compression springs or a combination of gas springs and compression springs are used to assist the sitting person into a standing position.

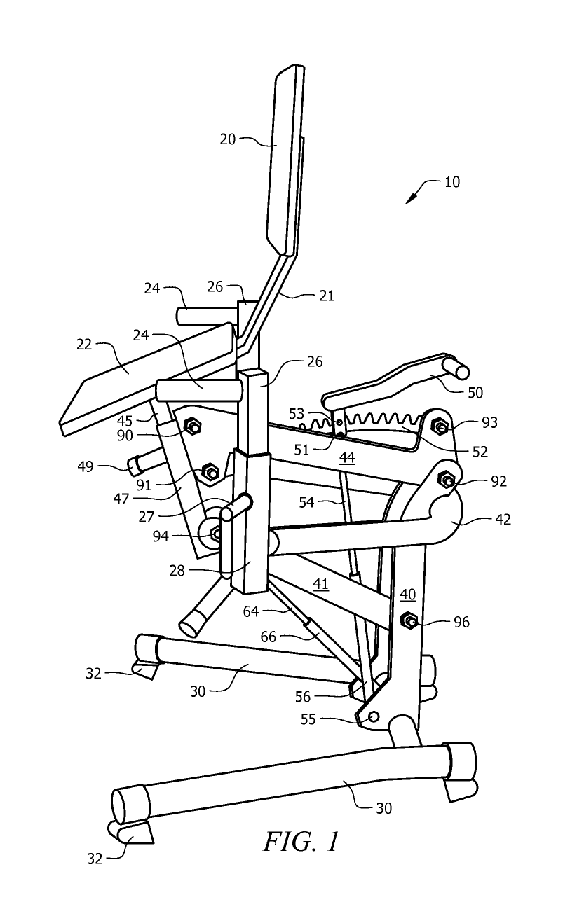

Referring to FIG. 1, a side perspective view of an assist chair system 10 of a first embodiment is shown. In this example, the assist chair system 10 includes an adjustable gas spring mechanism 50/51/52/53/54/56. The adjustable gas spring mechanism 50/51/52/53/54/56 is a means for capturing energy from a user sitting and later releasing the energy when the user transitions from the sitting position to the standing position.

In this example, the adjustable gas spring mechanism 50/51/52/53/54/56 has a slide rail 52 with teeth or notches that hold the engagement pin 53 at a selected position on the slide rail 52. A first end of the slide rail 52 is affixed to an upper pivot arm 44 neat the seat 22 by a bolt 91 and a distal end of the slide rail 52 is affixed to a distal end of the upper pivot arm 44 near a point at which it pivotally attaches to a riser 40 by a bolt 93. The riser 40 is interfaced to a base 30/32 of the assist chair 10.

The adjustable gas spring mechanism 50/51/52/53/54/56 adjusts by lifting the adjustment handle 50 and positioning the upper end engagement point 51 at a different point on the slide rail 52, thereby increasing or decreasing the distance between the engagement point 53 and the pivot point 55 at which the adjustable gas spring 54/56 attaches to the riser 40. In this way, lesser or greater spring force is loaded when the user sits and pushes upward and forward when the user lifts into the standing position.

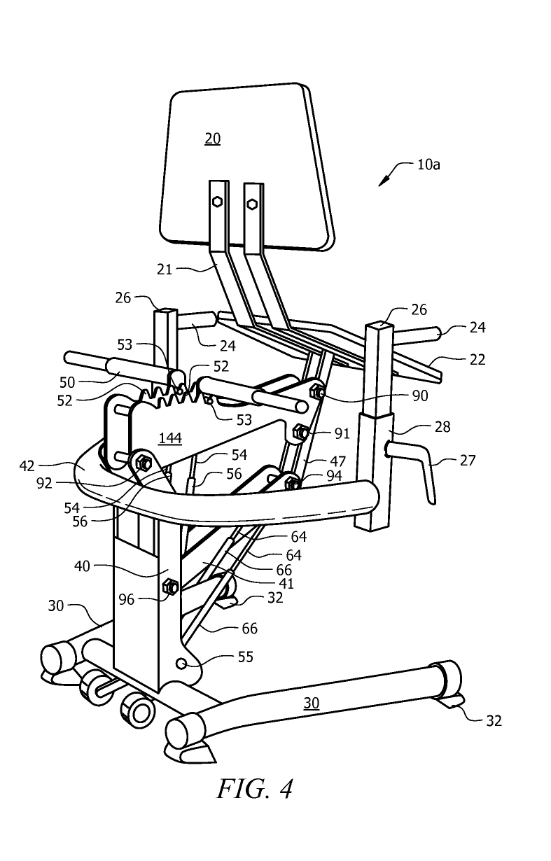

Again, the adjustable gas spring mechanism 50/51/52/53/54/56 is the preferred spring return mechanism. In some embodiments, multiple adjustable gas spring mechanism 50/51/52/53/54/56 are used (see FIG. 4). In such, it is preferred, though not required, that each of the gas springs 54/56 have different force values to provide greater range of adjustment. In some embodiments, other force loading mechanism are anticipated, either replacing or augmenting the gas spring(s) 54/56 with other devices such as compression springs, opposing polarity magnets, torsion springs, etc.

Likewise, the adjustment mechanism 50/51/52/53 shown in FIGS. 1-4 uses a slide rail 52 to provide adjustment stops. Any other adjustment mechanism such as a worm gear and a crank or a smooth bar and locking screw knob instead of a slide rail 52 are anticipated as equivalent mechanisms that achieve the same goals.

The frame system, seat 22 and seat back 20 are shown as examples and any other frame system and/or seat system are anticipated for providing support and comfort to the user of the assist chair system 10 while sitting. The assist chair system 10 provides assistance to the user in transitioning from a seated position to a standing position, but does not do all of the work for the user. The user is required to exert some amount of effort to lift them into the standing position. The adjustable gas spring mechanism 50/51/52/53/54/56 provides adjustability for a rehabilitating user to gradually provide more of the lift from their muscles and less from the assist chair system 10 until, eventually, the user is able to transition from a seated position to a standing position without the need of the assist chair system 10. Such gradual weaning is not possible with power assist chairs of the prior art that are not adjustable, do not push the user slightly forward and do not require the user to exert significant upward and outward muscle movement in order to achieve a standing position. Therefore, a user of the prior art devices will not improve muscle tone of those muscles used in transitioning from a seated position to a standing position. Furthermore, devices of the prior art do not provide gradual adjustments as the disclosed assist chair system 10, accommodating user with different capabilities, weight, muscle tone, etc. Furthermore, the devices of the prior art do not assist in transitioning from a seated position to a standing position by pushing upward and forward as the disclosed assist chair system 10.

It is anticipated that, for rehabilitation, the user will set the adjustable gas spring mechanism 50/51/52/53/54/56 to a position that provides maximum force for the user's weight. As the user builds strength, the adjustable gas spring mechanism 50/51/52/53/54/56 is then adjusted to provide less and less force, thereby relying more and more upon the user's own muscles. Eventually, the user is able to transition from the sitting position to the standing position without any force and can resume normal life, transition from the sitting position to the standing position from any standard chair, etc.

The disclosed exemplary assist chair system 10 includes a base portion for interfacing with the floor. Again, this is an exemplary assist chair system 10 and many other configurations of components that achieve the same or similar results are anticipated. The exemplary base portion includes leg bars 30 and non-slip floor guards 32. Although any structurally sufficient materials are anticipated, the frame, including leg bars 30 is anticipated to be made of metal such as steel, iron or aluminum or be made of a structural plastic, etc. The non-slip floor guards 32 are preferably made of a sturdy, high-friction material such as rubber that will reduce slippage of the assist chair system 10 across a smooth floor.

The exemplary assist chair system 10 has a frame system with the riser 40. The riser 40 is fixed to the base portion 30/32 maintaining a substantially vertical position with respect to the base portion 30/32. The upper pivot arm 44 and a lower pivot arm 41 pivotally interface the seat 22 and seat back 20 to the riser 40. The interplay of angles provided by the two pivot arms 41/44 preferably provide both up/down travel of the seat 22 and seat back 20 as well as forward/backward travel of the seat 22 and seat back 20 to help push the user forward when the user transitions from the sitting position to the standing position. Although forward motion is preferred to help push the user forward when the user transitions from the sitting position to the standing position, in some embodiments the user is pushed upwards and not forward.

Both the base portion 30/32 and the riser 40 provide a means for interfacing the assist chair to a floor or other surface.

In the example shown, a first end of the upper pivot arm 44 is pivotally connected to an upper pivot location 90 of the seat lift member 47 and a distal end of the upper pivot arm 44 is pivotally connected to an upper pivot location 92 of the riser 40. Likewise, a first end of the lower pivot arm 41 is pivotally connected to a lower pivot location 94 of the seat lift member 47 and a distal end of the lower pivot arm 41 is pivotally connected to a mid-located pivot location 96 of the riser 40. In this embodiment, as the seat lift member 47 lifts, the seat 22 leans forward, and, therefore, both assists in lifting the user as well as pushing the user slightly forward, helping the user transition between the sitting position and the standing position.

The assistance spring 54/56 is preferably a gas spring 54/56 and is the primary lift assistance device. As the user sits on the seat 22, the assistance spring 54/56 and the seat support gas spring 64/66 compress, thereby storing energy and slowly lowering the user from the standing position to the sitting position. As the user begins to transition from the sitting position to the standing position, the energy stored in the assistance spring 54/56 and the seat support gas spring 64/66 provide force to assist in pushing the user upward and forward. The amount of force stored in the assistance spring 54/56 is adjusted by the adjustment mechanism 50/51/52/53 or equivalent adjustment mechanism. Given an assistance gas spring 54/56 of a given resistance, more force is required to compress the assistance spring 54/56 when the adjustment mechanism 50/51/52/53 is positioned towards the front (adjustment mechanisms 50/51/52/53 is positioned closer to the seat 22). Gas springs 54/56/64/66 are preferred for their specific force curves, requiring less force for the initial travel of the piston 54/64 into the pressure chamber 56/66 and increasingly greater force as the piston 54/64 travels further into the pressure chamber 56/66. Other forms of springs, opposing magnets, combinations of springs or combinations of springs and gas-springs are also anticipated. Such springs provide different force curves, both during compression and release.

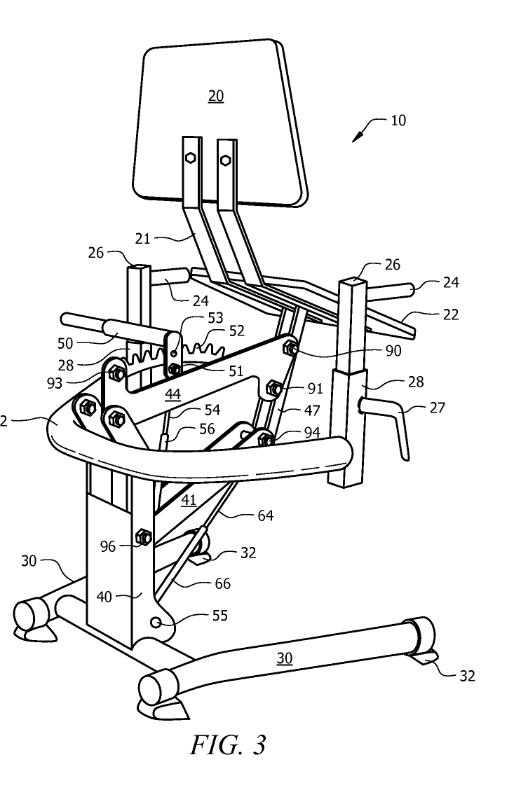

The height of the seat 22 is optionally adjustable with a seat adjustment pin 49 interfaced to the seat lift member 47 in which the height of the seat 22 is adjusted by the pin 49 as known in the industry. Although many such adjustment mechanisms are known, one such includes a seat bar 45 telescopingly interfaced to the seat 22 having holes, through which the pin 49 locks the seat bar 45 in position with respect to the seat lift member 47. In other embodiments the seat 22 is affixed to the seat lift member 47 and is not adjustable as shown in FIGS. 3 and 4. When seat height adjustment is desired, any seat height adjustment mechanism known in the industry is anticipated.

The seat 22 and optionally the seat back 20 and seat adjustment mechanism 45/47/49 provide a means for supporting a user of the assist chair.

A seat back 20 is preferred, though not required. In embodiments having a seat back 20, the seat back 20 is interfaced to the seat 22/seat bar 45/seat lift member 47, preferably through a resilient connecting bar 21 that provides a slight amount of bending under pressure from the user's back, though any seat 22 and seat back 20 arrangement is anticipated including no seat back 20 (e.g. a assist stool system).

Optionally, it is preferred to include hand grips 24 for the user to press down upon when sitting and when lifting their body into a standing position. The grips 24 are supported by supports 26/28. In some embodiments, the supports 26/28 are fixed (not adjustable). In alternate embodiments, the supports 26/28 provide height adjustment to the grips 24 by telescoping into each other. In such embodiments, a locking mechanism such as a pin 27 locks the upper support 26 in position with respect to the lower support 28 as known in the industry. Any known adjustment mechanism is anticipated. Although not required, an optional lateral structural member 42 connects each of the arm support risers 26/28 to each other for additional rigidity. The hand grips 24, supports 26/28, pin 27 and lateral structural member 42 provide a means for grasping for the user as they transition from sitting on the assist chair 10 to the standing position.

Although the assist chair 10 is provided for a user to assist in the transition from sitting to the standing position, other uses are anticipated related to rehabilitation and/or exercise. For example, another intended use includes the user repeatedly pushing their body upwardly using the hand grips 24, thereby exercising their upper body muscles.

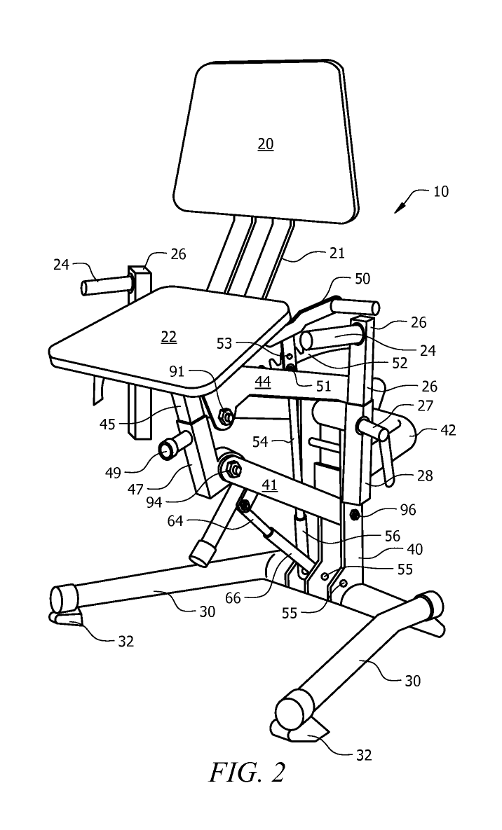

Referring to FIG. 2, a front perspective view of an assist chair system 10 of the first embodiment is shown.

Referring to FIG. 3, a rear perspective view of an assist chair system 10 of the first embodiment is shown. In this example, the height of the seat 22 is fixed to the seat lift member 47 as known in the industry. The seat 22 and optionally the seat back 20 provide a means for supporting a user of the assist chair.

A seat back 20 is preferred, though not required. In embodiments having a seat back 20, the seat back 20 is interfaced to the seat 22/seat lift member 47, preferably through a resilient connecting bar 21 that provides a slight amount of bending under pressure from the user's back, though any seat 22 and seat back 20 arrangement is anticipated including no seat back 20 (e.g. a assist stool system).

Referring to FIG. 4, a rear perspective view of an assist chair system 10A of an alternate embodiment is shown. In this example, the assist chair system 10A includes two adjustable gas springs mechanism 50/51/52/53/54/56. The adjustable gas spring mechanisms 50/51/52/53/54/56 adjust by lifting either of the adjustment handles 50 and positioning the upper end engagement point 53 at a different point on the slide rails 52, thereby increasing or decreasing the distance between the engagement point 51 and the pivot point 55 at which the adjustable gas springs 54/56 attach to the stationary portion of the riser 40. In this way, lesser or greater gas spring force is loaded when the user sits or pushes upward and forward when the user lifts into the standing position. By having multiple gas spring mechanisms 50/51/52/53/54/56, a greater range of adjustment is provided. When multiple gas spring mechanisms 50/51/52/53/54/56 are provided, it is preferred that each of the gas springs 54/56 have different force specifications. For example, in a two gas spring mechanisms 50/51/52/53/54/56, the second gas spring 54/56 has, for example, 1/10^{th} of the resistance as the first gas spring 54/56, thereby providing a course adjustment using the first gas spring mechanisms 50/51/52/53/54/56 and a fine adjustment using the second gas spring mechanisms 50/51/52/53/54/56. It is anticipated that the gas spring adjustment mechanisms 50/51/52/53 are marked with graduation marks, in some embodiments step numbers while preferably labeled with numbers that are useful to the user such as weight in pounds or kilograms, etc. In some embodiments, the labels are numerical and the user references a chart that correlates the user's weight and support required with a setting on the slide rail 52. For example, a user weighing 220 lbs and needing 70% support sets the slide rail 52 (single gas spring system) to the maximum setting. For the same user and 65% support, the user sets the slide rail 52 to the next setting and so on until the user needs only 30% support and the slide rail 52 is set to the lowest setting. If the user weight less, for example 190 lbs, the user sets the slide rail 52 to the second setting for 70% support instead of the highest setting as did the user weighing 220 lbs.

Again, the adjustable gas spring 54/56 is the preferred spring return mechanism. In some embodiments, other force loading mechanism are anticipated, either replacing or augmenting the adjustable multiple gas spring mechanisms 50/51/52/53/54/56, such as compression springs, opposing polarity magnets, torsion springs, etc.

Likewise, the adjustment mechanism 50/51/52/53 shown in FIG. 4 uses two slide rails 52 to provide adjustment stops for each of the adjustable gas springs 54/56. Any other adjustment mechanism or combination of different adjustment mechanisms such as a worm gear and a crank or a slide bar and locking screw instead of the slide rail 52 are anticipated as equivalent mechanisms that achieve the same goals.

In this embodiment, the slide rails 52 are integrated into or part of the upper pivot arm 144, reducing the number of parts needed while performing the same function.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An assist chair comprising:
a base;
a seat, the seat interfaced to a seat lift member;
a riser affixed to the base;
an upper pivot arm interfaced to the seat lift member and pivotally interfaced to the riser;
a lower pivot arm interfaced to the seat lift member and pivotally interfaced to the riser;
a spring member adjustment mechanism interfaced between the riser and the seat lift member; and
at least one spring member pivotally connected at a first end to the riser and at a second end to the spring member adjustment member, whereas the at least one spring member compresses and stores energy when a user sits on the seat and the spring member expands and releases the energy when the user transitions from a sitting position to a standing position, assisting the user by pushing upward and forward.

2. The assist chair of claim 1, wherein the at least one spring member is at least one gas spring.

3. The assist chair of claim 2, wherein the at least one spring member is two gas springs and a first gas spring of the two gas springs has a different force curve than a second gas spring of the two gas springs.

4. The assist chair of claim 1, further comprising an assistance spring, a first end of the assistance spring interfaced to the seat lift member and a second end of the assistance spring interfaced to the riser.

5. The assist chair of claim 4, wherein the assistance spring is another gas spring.

6. The assist chair of claim 1, wherein the seat further comprises a seat back.

7. A method of rehabilitation comprising:
(a) providing an assist chair comprising:
a base;
a seat, the seat interfaced to a seat lift member;
a riser affixed to the base;
an upper pivot arm interfaced to the seat lift member and pivotally interfaced to the riser;
a lower pivot arm interfaced to the seat lift member and pivotally interfaced to the riser;
a spring member adjustment mechanism interfaced between the riser and the seat lift member;
at least one spring member pivotally connected at a first end to the riser and at a second end to the spring member adjustment member;
(b) responsive to a user sitting on the assist chair, the at least one spring member compressing and storing energy; and
(c) responsive to a user exerting effort to transition from a sitting position to a standing position, the spring member expanding and releasing the energy, thereby assisting the user by pushing upward and forward on the user.

8. The method claim 7, wherein the assist chair further comprises arm rests.

9. The method of claim 8, further comprising repeatedly (d) pushing up on the arm rests to raise the user's body and (e) stopping the pushing up on the arm rests to lower the user's body, thereby exercising upper body muscles of the user.

10. The method of claim 7, further comprising an assistance spring, a first end of the assistance spring interfaced to the seat lift member and a second end of the assistance spring interfaced to the riser.

11. The method of claim 10, wherein the assistance spring is another gas spring.

12. The method of claim 7, wherein the seat further comprises a seat back.

13. An assist chair comprising:
means for interfacing the assist chair to a floor;
means for supporting a user of the assist chair;
means for capturing energy from a user sitting on the means for supporting the user, the means for capturing the energy releasing the energy when the user transitions from a sitting position on the assist chair to a standing position, thereby assisting the user.

14. The assist chair of claim 13, wherein the means for capturing the energy is adjustable.

15. The assist chair of claim 13, wherein the means for capturing the energy includes at least one gas spring.

16. The assist chair of claim 13, wherein the means for capturing the energy includes two gas springs and a first gas spring of the two gas springs has a different force curve than a second gas spring of the two gas springs.

17. The assist chair of claim 13, further comprising an assistance spring, a first end of the assistance spring interfaced to the means for interfacing the assist chair to a floor and a second end of the assistance spring interfaced to the means for supporting the user of the assist chair.

18. The assist chair of claim 13, wherein the means for supporting the user of the assist chair further includes a means for adjusting a height of the means for supporting the user of the assist chair.

19. The assist chair of claim 13, wherein the means for supporting the user of the assist chair further includes a means for grasping, the means for grasping provides adjustable height handles to the user of the assist chair and the means for grasping attached to the means for interfacing the assist chair to a floor.

20. The assist chair of claim 13, wherein the means for capturing the energy from the user includes:
an upper pivot arm interfaced to the means for supporting with the user and pivotally interfaced to the means for interfacing the assist chair to the floor;
a lower pivot arm interfaced to the means for supporting with the user and pivotally interfaced to the means for interfacing the assist chair to the floor;
a spring member adjustment mechanism interfaced between the means for interfacing the assist chair to the floor and the means for supporting with the user; and
at least one spring member pivotally connected at a first end to the means for interfacing the assist chair to the floor and at a second end to the spring member adjustment member.
